(19) United States
(12) Patent Application Publication
(10) Pub. No.: US 2010/0070161 A1
(43) Pub. Date: Mar. 18, 2010

(54) Multimode Navigator device

(76) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(21) Appl. No.: 12/210,196

(22) Filed: Sep. 14, 2008

(51) Int. Cl. G01C 21/36

(52) U.S. Cl. 701/201; 701/207; 701/213; 701/200

(57) ABSTRACT

An improved navigator system turns off a display in one mode of operation. The operation in that mode can use enhanced mapping information that announces landmarks and other information to guide the user to a destination with only audio. The latest set of information can be stored in the navigator and used even if it is old information.

### BACKGROUND

The simplified structure of a navigator device has made it easier to put these navigator devices into various structures such as handheld PDAs, cell phones, and the like. It is desirable to make these devices more inexpensive and energy efficient.

### SUMMARY

The present application describes a navigator device which can be used in a number of different modes and locations.

### BRIEF DESCRIPTION OF THE DRAWINGS

FIG. 1 shows a navigator device with a universal mount;

FIG. 2 shows a block diagram of the preferred navigator device;

FIG. 3 illustrates a flow chart of operation of this navigator device according to a first embodiment;

FIG. 4 illustrates a flow chart of operation of a second embodiment of the navigator device which operates without a display in order to save battery power; and

FIG. 5 shows a third embodiment using a networked navigation device.

### DETAILED DESCRIPTION

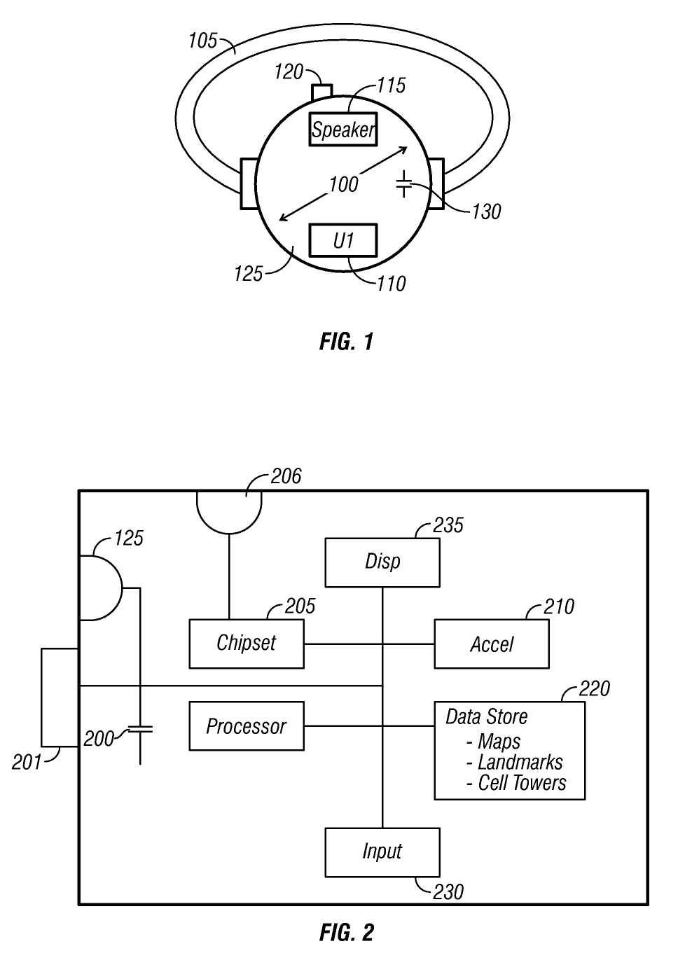

An embodiment shown in FIG. 1 shows a package and mount for a navigator device. In operation, the navigator device is preferably less than 2 inches across on the dimension shown as 100. The device is shown on a strap 105, of a type intended for wearing either around the user's arm or leg, or on an automobile or a rearview mirror for example. The front panel includes a user interface input part 110, an annunciating part 115, and a port 120, e.g., charging, data and/or USB. In an embodiment, the entire front surface 125 of the device may include a solar cell that charges an internal battery 130. According to an embodiment, the navigator device is capable of operating in a number of different modes, including modes which minimize power consumption.

FIG. 2 illustrates a block diagram of a navigator device. A battery 200 supplies the power. The battery may be a rechargeable battery, or replaceable batteries such as AA batteries or some of both. Replaceable batteries can be used because this system can have a reduced power consumption. The system may also include an input for a car cord or other form of power shown as 201. The power drives all the operative parts of the unit. In FIG. 2, those operative parts include a GPS chipset 205 and associated GPS antenna 206; supplemental position detecting elements such as an accelerometer and/or compass 210; a processor 215, and a data storage unit 220 which can be a hard drive or solid state storage unit. There can also be an input output device 230, and can be a keyboard or a voice recognition system. A display 235 may display certain aspects including a soft keyboard in at least one embodiment. Solar cell 125 may be on the outer surface of the device to obtain sunlight for charging the batteries when there is a clear view of the sky, as needed for the GPS antenna 206. Since the antenna 206 preferably has a clear view of the sky, the solar cell 125 may be on that same surface as the antenna, to also receive the same clear view of the sky.

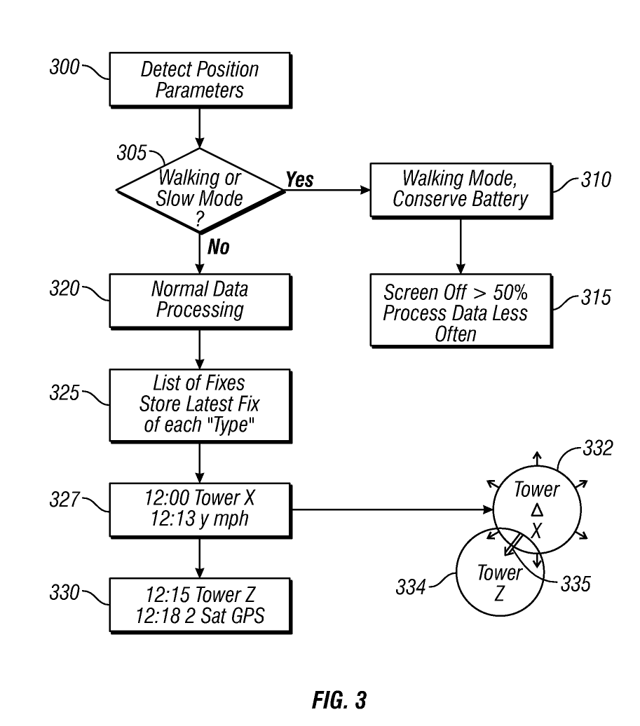

FIG. 3 shows an operation where at 300, the system, e.g. the chipset/accelerometer/processor and data storage detect current parameters indicative of current position. This may detect a number of different kinds of parameters including GPS location information, information from cell towers, accelerometer information, and any other information that is or can be indicative of a current location.

At 305, the system automatically detects whether a user is walking/running versus moving in a vehicle. The walking mode may be detected, for example, if the user is moving at a very slow rate of speed for a period of minutes, e.g., 5 minutes. This might also detect the user of the navigator being in a traffic jam, for example. However, while in a traffic jam, the navigator could react in a similar way to that of walking. This could be overridden by touching a screen of the navigator to return to the normal mode. However, this may be useful, since the navigator may react in the same way during a traffic jam: it may turn off the display because the user does not need to know anything about the navigation, and the display should be able to turn off to conserve power. When the user parks, and if the user has neglected to turn off the navigator, the display should be turned off, which would again be detected.

Therefore, these embodiments may turn off the display or turn off the display for some duty cycle, e.g. 90% of the time, when the navigator detects the movement at less than a specified speed.

When walking/slow movement mode is detected, the processing and display is set to walking mode at 310 in order to save the battery and/or power consumption. The walking mode display may turn the screen off, turning it on only when some action is necessary. For example, after the user carries out a turn, the screen will automatically be blanked until a time when the user needs to do something else like carry out a turn or go straight. The screen might stay continually off until some new action is necessary. In another embodiment, the screen may come on at a duty cycle, e.g., at 90%.

In addition, at 315 in the walking mode, the processing of the data is carried out less often. For example, in driving mode parameters of 300 may be detected every second. In walking mode, those parameters might be only detected every 30 seconds or every one minute or every 5 minutes, or any other interval.

If the navigator is not detected to be in walking mode at 305, the normal mode is set at 320. The navigator may consume more power in the normal mode. Even in the normal mode, however, the system can turn the screen off in between objects in order to conserve on power.

GPS devices require a line of sight to a satellite for navigation. In fact, to get an adequate GPS fix, it is usually thought that you need between four and six satellites to be in view. Different techniques such as WAAS have been used to improve the GPS capability within a navigator. However, it is still not usually possible to obtain GPS fixes indoors.

According to 325, the system stores a list of types of “fixes”. Each fix is of a different type and represents a different kind of information from which navigation information can be obtained. In certain modes, such as when there is an adequate view of a satellite, the navigator will work perfectly, and not need these fixes and not have any substantial uncertainty. However, in other modes, the fixes may help to ascertain the actual position based on accumulating useful information from a group of different pieces of information, each of which is, by itself, provides only uncertainty about the position.

The data storage may also store information indicative of maps, and may also store positions of different cell towers. The device may receive cell tower information either direct from the cell towers or by intercepting communications from a local cell phone. Obtaining cell tower information may make it possible to help ascertain the actual location of the device via the locations of those cell towers. However, knowing the cell tower only tells the system that the unit is within the reception area of that cell tower, not where in the reception area it is located. Therefore, this allows defining a circle, within which the navigator is located.

According to an embodiment, the latest fix of each “type” can be stored at 325. Each fix may displace earlier fixes of that type, so that the latest fix of any one type may be stored.

For example, 327 shows that at 12 o'clock the system saw tower x, then at 1205-1213, the system was going y miles per hour. There are uncertainties based on unreliability of the compass/bad GPS fix, etc. This unreliability produces a zone of uncertainty. The resultant map part is shown in 331 where there is a circle 332 representing the area of uncertainty of receiving signals from tower x. Moreover, since it is known that the device is moving, the arrows may represent the zone of uncertainty for the movement.

The next fix may be at 330, where at 12:15 shown at step 340, the system sees tower z. Tower z is in area 334. However, the overlap 335 between the previous uncertainty zone 332, and the new uncertainty zone 334, with the speed fix arrow is the likely new fix. Accordingly, many of the uncertainty arrows can be removed after seeing the tower z.

When seeing the tower z at 1215, the previous fix for tower x may be deleted, since there is a later tower fix. However, the last detected movement needs to stay until a new movement is detected.

In a similar way, good and bad GPS fixes can be detected, all used to shift the area of the picture or map with or without uncertainty. For example, a gps fix received from only two satellites can create another data uncertainty zone to add to the zone of uncertainty and to narrow down the location even further.

While this will not produce certain information, it still allows the user to be within a zone of uncertainty.

Taking an overlap of the uncertainty variables creates a more certain location. If a sufficient number of variables are obtained, then the multiple different items of information when used together can be used to triangulate among different zones of uncertainty for a new position. For example, if there are a number of zones of uncertainty from a number of different items, the zones may overlap forming a new postulate area, such as 335 as the likely location of the navigator.

This system keeps the last position information, certain or uncertain and uses it as the most likely location. Hence, when the navigator is taken indoors, the last accurate fix will represent the likely location of the user. By storing last accurate fixes, the user's location can be determined even when a current GPS signal is not obtained or even when no signal is obtained.

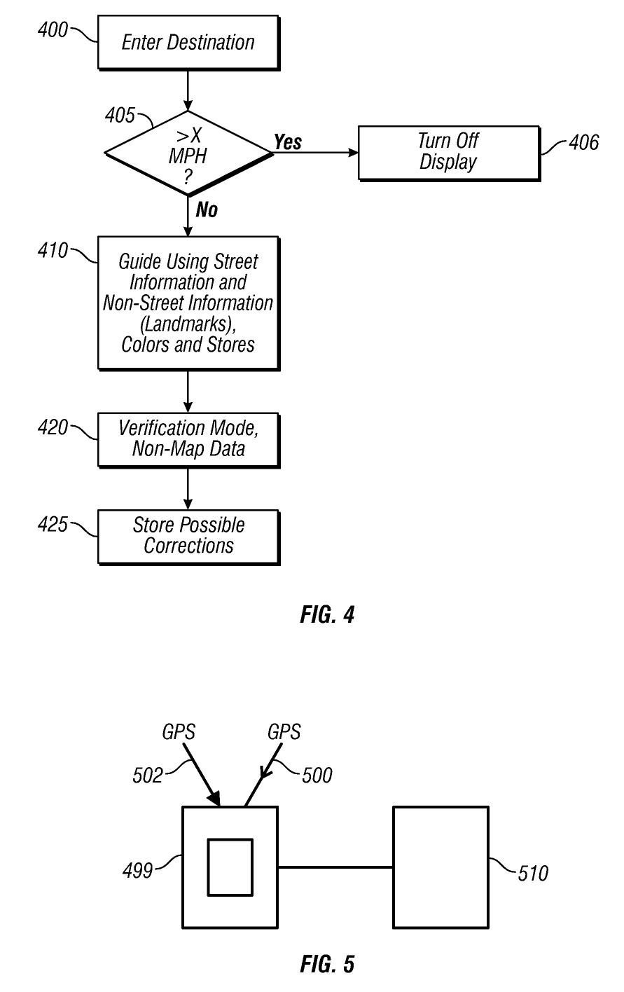

Another embodiment is shown in FIG. 4. This embodiment allows navigation without any display or with the display turned off. Operation without a display can save power. It can reduce the cost of a navigator device, since a no-display device or minimized display device can be used. It can also improve safety, since it can be dangerous for a person to have to look at the navigator while driving.

A destination is entered at 400.

If the device is in “safe driving mode”, the display is turned off at 406 as soon as the navigator (e.g., the GPS) detects the device moving more than 5 miles per hour at 405. This may be detected, for example, by sensing positions, and times for those positions, and determining a speed by the time between positions. One other mode may allow the display to be on and active only while the user is not travelling more than 5 miles per hour, or only while the user is completely stopped, or when going less than a certain speed. When the vehicle starts running, the navigation shifts to audio only, using the enhanced audio guidance as described herein. This prevents looking at the display, thereby enhancing safety.

The present application recognizes that properly detailed audio instructions can be used to guide a driver or other person along a path. The audio instructions given herein provide audio instructions sufficient to allow navigation.

The embodiment analyzes a local area and provides information that orally guides the driver. It uses at least one item of non-street based information for the guiding of the driver. This information is obtained by analyzing maps, and mashing up the map information with other public sources of information: locations of stores, traffic lights, photo based street services, such as MSN virtual earth and Google Street view, and others. For example, map data for main street in Anytown USA, numbers 100-200 may be combined with picture data for that stretch of street, store data (e.g., grocery stores, department stores etc) for that stretch of street, and other information. This creates enhanced map information that includes more than just the street mapping data. At least one item of non-street information is used for the guidance. This is based on the inventor's recognition that other information of this type can be correlated with street data and used to assist with guidance.

The map is analyzed to find information that the driver might need to know where to turn and what to do without being able to see a map of that situation. This includes, but is not limited to:

Turns left and right that come before the turn that the user needs to take. Oral commands will say “there is a street on xxx before your turn, then you need to turn yyy”.

Landmarks, including points of interest, before and near the turn. Oral commands will say “turn zzz just before the <pointofinterest_z123>” , where <pointofinterest_z123>is a variable that is filled in from the enhanced map information.

Traffic landmarks, such as traffic lights, stop signs, street signs. Oral commands will say “turn right at the first street after the traffic light”.

Colors of items, e.g., turn “left after the yellow building”.

Stores/restaurants, e.g., “turn left just before the taco bell on the left”.

Other recognizable features can also be stored and announced.

For this embodiment, the map should use as many landmarks and points of interest as possible. This may use maps created by street level camera type map creators, e.g., like those made on Google maps. These can include locations of street level features. It can also include colors of different features. For example, the audio command may say “turn right after the yellow sign”.

The landmarks can be stored, or they can be obtained in real time from an internet or other wireless connection to public sources of information and/or mashups of the types discussed herein. This way, the information about landmarks stays reasonably current.

Other commands might be :“okay you need to turn here”, or “not this one but the next one”. Or “see that light up there, that's where you need to turn”.

Another embodiment, may create more sophisticated maps as mashups between the mapping information and other information such as picture data, store data (locations of groceries, walmarts, gas stations, etc) and others. It may be based on website information that is combined with map data.

Another is “turn left after the Arco gas station on the right”.

The process starts at 400 where the user's current location and destination are determined for the purpose of navigation. This may be done in any desired way e.g. by entering the information on a user interface, or by transferring the information from some other unit such as a pda, or based on an internet connection. According to one embodiment, the system may use voice recognition. In another embodiment, the system may allow destinations to be entered on other devices and transferred such as cell phones and PDAs. Yet another device may have a user interface on the unit itself such as a soft keyboard. The navigator does not need to show anything, keeping the user's attention on the road, and also preventing the need for an overly complicated device.

Another embodiment may use the improved mapping and guidance system that shows at least one non-street landmark, along with a display.

As an example, at 410, the system may operate by saying “you are now on Main Street and you are going to need to turn left in 750 feet near the Walmart”. This can be based on map data, where the system automatically determines some distance, called a “warning distance” before a next turn that will be necessary, and announces the next action at that warning distance, and combines that with a known landmark.

The system also may use a landmark verification mode as in 420, that is used at intervals of time, or based on some other parameter, e.g., every 5 minutes or some other interval, and during shorter intervals once within the warning distance. This mode uses landmarks along the route. It asks the user to verify that the landmarks are being seen. For example, the system can announce “do you see a Safeway on your left?” or “Do you see a Safeway on the left, if you keep quiet I will assume you do.” or “Say ‘help’ if you don't see a Safeway on the right”. All of these landmarks may be available from the mashed-up map data, which shows not only the street, but also the things that are along the streets such as a Safeway.

You can answer no, which might mean they either you don't see the landmark, or that the map needs correction. A negative answer to the landmark may be stored in the unit at 425, and later used as a map correction element.

If too many people report that they do not see the point of interest, however, e.g., more that 100 people or 0.1% of users, then the landmark should be reconsidered to determine its accuracy.

If you answer yes to seeing the landmark, then the system answers with feedback about your position, such as “good, you're almost there” or, “you're on the right path, just keep going”.

When coming upon a turn, the system will analyze information about the intersection. If it is a simple intersection, the system will simply say “You're coming up upon an intersection, and you need to turn left at that intersection”. However, very often, the intersection has multiple turns or directions. The system analyzes the intersection to determine the different places and numbers of turns. Alternatively the mapping data can include information for each intersection, to be sent to a user to tell them how to turn at that intersection. Based on information in the map, the system will provide information about how and where to turn.

Example messages may include “there are going to be two streets ahead where you can turn left; you need to turn at the second one”. If landmarks are stored, the system may say “you need to turn at the 2nd St., there will be a gas station at the far left corner on that street”. The system may say “you need to wait until you pass the yellow house before you turn left”.

Other announcements that the system might make include “you're going to need to turn right in 400 feet, you might want to get into the right lane and think about slowing down”. The system may not be able to tell if you're in the left or right lane, but can use the speedometer or can use the GPS signal to determine speed by sensing movement, and dividing that movement by an amount of time it takes to go that amount of distance.

Another message is “You should see a street sign that says “Main Street”.

Another is “you are on Your Destination street and there is a landmark that is about a half a mile ahead. Even numbers are on the right.”

Another message is “Slow down your almost there”, which can be based on the user being with 200 feet of their destination and going faster than 30 mph as determined using speedometer/gps.

The user can always ask for feedback by saying things like “how am I doing”. The voice recognition receives the message and returns an answer “you're doing fine, there are no turns for 1½ miles”.

“You should be there in 15 minutes, at 12:30 PM”

Another embodiment disclosed is a network-based operation shown in FIG. 5. In this network-based operation, affordable communicators such as a cell phone may be used for the network operation, by receiving GPS signals, shown as 500, and/or other positioning signals, e.g., cell tower signals shown as 502. Those signals are processed either in the internal processor of the cell phone or by sending them to the remote network shown as 510. This unit can provide the enhanced oral instructions like in the third embodiment. These oral instructions, may be announced in the speakerphone mode of the speaker. Again, as in the previous instructions, this mode announces detailed directions and landmarks, asks questions and other information.

Yet another embodiment may provide a learning system in combination with any of the previous embodiments. When a user makes a wrong turn or misses a turn, the system asks the user if there is a reason why they missed the turn. The user might answer in plain English that the intersection wasn't described well, or I could have used a better landmark, or “I couldn't get in lane soon enough”. These answers can be uploaded to a network and shared so that a troubleshooter can study these answers, which can allow better formation of oral instructions.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above describes certain kinds of operation over the internet, any other way of interacting via a shared network can be similarly controlled in this way. Other landmarks besides those specifically described herein can be used. Any Also, other techniques of saving power can be used.

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

The navigators as described herein are special purpose computers that run a program allowing them to operate as a navigator and to navigate to different locations. However, they may also be general purpose computers such as desktops or laptops.

The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A navigator system, comprising:
a first part, which determines information indicative of a location of the navigator, said first part including at least one portion that receives first information indicative of a location, wherein said first information includes an certainty about the location it represents, and stores the first information about the location, wherein said navigator system forms an output information indicative of a current location based on said stored information, even when that stored information is not current stored information.

2. A system as in claim 1, further comprising storing second information, wherein said second information is from a different source than said first information.

3. A system as in claim 1, wherein said stored information includes a plurality of different information types, each of the different information types representing information obtained from a different source.

4. A system as in claim 3, wherein each of said information types includes a most recently obtained information of said information type, and wherein said navigator system forms said output based on said multiple different information types from each of the different items of most recent information.

5. A navigator system as in claim 1, further comprising forming an output information indicative of a most current calculation about the current location based on said stored information, when no new information is received.

6. A navigator system as in claim 3, wherein one of said information types includes information indicative of detection of a cell tower, and where said first part obtains a known location of said cell tower that has been detected by said information.

7. A navigator system as in claim 3, wherein one of said information types includes information indicative of speed at which the navigator is moving.

8. A system as in claim 1, wherein said navigation system includes a plurality of different uncertain pieces of information, each of which defines an area within which the navigation system can be located, and determines a most likely current location based on said intersections among multiple different pieces of information.

9. Navigator system as in claim 1, further comprising a display, and a display mode controller which turns off the display during at least one mode of navigation of said navigator system.

10. A system as in claim 9, wherein said display mode controller automatically determines when to turn off the display based on a determined speed of operation.

11. A navigator system, comprising:
a first part that determines a speed of movement of a navigator that allows guiding a user from a location to a destination;
a second part, that controls producing output on a display of the navigator; and
a display control part, responsive to the speed of the movement of the navigator, which automatically enters a mode in which output is not continually produced on a display of the navigator, based on said determined speed of movement of the navigator.

12. A navigator system as in claim 11, wherein said first part includes a global positioning system, that automatically determines said speed based on positions detected by the global positioning satellite, and times when those positions were detected, and calculates a velocity based on said positions and times.

13. A navigator system as in claim 11, wherein said first part includes an accelerometer that determines the speed.

14. A system as in claim 11, wherein said display control part turns off the display of the navigator at least for part of the operation time when the speed is detected to be greater than a certain amount.

15. A system as in claim 11, wherein said display control part turns off the display of the navigator for at least a part of the operation time when the speed is detected to be less than a certain amount.

16. A system as in claim 11, wherein said navigator includes an audio part, that produces outputs announcing instructions for navigation, wherein said instructions include at least one landmark for the navigation, where the landmark includes at least one recognizable feature along the route that is something other than a street name.

17. A system, comprising:
a position detecting part which automatically detects a position;
a computer part, that stores mapping information, wherein said mapping information includes at least street names, and landmark information other than said street names, said landmark information including recognizable features adjacent to said street names, said recognizable features being features that a user who is driving on said street can recognize other than the street names;
wherein said computer part causes navigation along the route between a current position that is automatically detected by said position detecting part, and a entered position representing the desired destination, and causes audio announcement of information about said route including at least announcement of said at least one of said landmarks.

18. A system as in claim 17, wherein said landmarks include stores which have names, and said computer part automatically announces the names of the stores.

19. A system as in claim 17, wherein said landmarks include colors of the buildings along said street.

20. A system as in claim 16, wherein said landmarks include items which can be seen in a photo of a street, but which cannot be seen in a road map.

21. A system as in claim 17, wherein said landmarks include restaurants, and said computer part automatically announces the names of the restaurants.

22. A system as in claim 17, wherein said landmarks include gas stations, and said computer part automatically announces the names of the gas stations.

23. A system as in claim 17, wherein said computer part also makes at least one announcement that verifies a landmark that is near a current location of the navigator, and verifies that the landmark is along a correct current route of the user.

24. A system as in claim 17, wherein said position detection part stores a latest set of position data as stored information, and forms an output information indicative of a current location based on said stored information, even when that stored information is not current information.

25. A method, comprising:
using a position detecting part to automatically detect a position;
storing enhanced mapping information, wherein said enhanced mapping information includes at least street names, and also landmark information other than said street names, said landmark information including recognizable features adjacent to said street names, said recognizable features being features that a user who is driving on said street can recognize and are other than the street names;
using said position detecting part and said enhanced mapping information to guide a user along a route between a current position that is automatically detected by said position detecting part, and a entered position representing a desired destination,
said guide including audio announcement of information about said route including at least announcement of said at least one of said landmarks.

26. A method as in claim 25, wherein said landmarks include stores which have names, and said announcement includes the names of the stores to inform the user of said landmarks.

27. A method as in claim 25, wherein said landmarks include colors of the buildings along said street.

28. A method as in claim 25, wherein said landmarks include items which can be seen in a photo of a street, but which cannot be seen in a road map.

29. A method as in claim 25, wherein said landmarks include restaurants, and automatically announces the names of the restaurants.

30. A method as in claim 25, wherein said landmarks include gas stations, and automatically announcing the names of the gas stations.

31. A method as in claim 25, further comprising making an announcement that verifies a landmark that is near a current location of the navigator, and announces that the landmark is along a correct current route of the user.

32. A method as in claim 25, further comprising storing a detected position including a latest set of position data as stored information, and forms an output information indicative of a current location based on said stored information, even when that stored information is not current information.

33. A method as in claim 25, wherein said guide also provides a display, and turns off said display when detecting a speed of movement greater than a specified speed.

34. A method of making mapping information for a navigator, comprising:
combining street map information with photo information about items that are along the street; and
returning first information from the photo information along with second information from the street map information responsive to a request for mapping information.
